(19) United States
(12) Patent Application Publication
(10) Pub. No.: US 2022/0351156 A1
(43) Pub. Date: Nov. 3, 2022

(54) SYSTEMS AND METHODS FOR AUTHENTICATION USING EXISTING CREDENTIAL

(71) Applicant: Shopify Inc., Ottawa (CA)

(72) Inventors: Siavash GHORBANI, Toronto (CA); Carl RIVERA, Tuxedo Park, NY (US)

(21) Appl. No.: 17/244,142

(22) Filed: Apr. 29, 2021

(51) Int. Cl. G06Q 20/02; H04L 29/06; G06Q 20/38; G06Q 20/08; G06Q 20/40

(52) U.S. Cl. CPC G06Q 20/02; H04L 63/08; G06Q 20/3821; G06Q 20/085; G06Q 20/4014; H04L 2463/121; G06Q 20/18

(57) ABSTRACT

Disclosed herein are methods and systems for electronic authentication including receiving a purchase request from a browser application executing on a first electronic device; determining a user identifier associated with the purchase request; responsive to determining that the browser application does not satisfy a security threshold, identifying an active authenticated session for the user identifier, wherein the active authenticated session was generated using a second electronic device of a set of pre-authorized devices associated with the user identifier; generating a token for the purchase request before an expiration of the active authenticated session; and authorizing the purchase request using the token.

### TECHNICAL FIELD

This application relates generally to electronic authentication, and particularly to multi-device and multi-channel authentication.

### BACKGROUND

As the Internet technology era allows for easier connectivity using different platforms and devices, users are conducting online transactions on devices that may execute browser applications that do not comply with various security protocols (also referred to herein as deprecated or legacy browsers), such as gaming consoles or screen-less virtual assistant devices. However, conducting online transactions using deprecated browsers have created technical challenges.

First, deprecated browsers typically lack security features provided by non-deprecated browsers that are typically used on personal computer or mobile phones to protect data inputted by the users. The available features on the deprecated browsers may be obsolete and undesirable for particular exchanges of data. For example, most gaming consoles do not support secure payment channels. Therefore, conducting online transactions that involve inputting sensitive personal data (e.g., payment information or authentication data) may cause security concerns. Second, many deprecated browsers do not provide user-friendly interfaces for the purpose of authentication or inputting information.

### BRIEF DESCRIPTION OF THE DRAWINGS

The accompanying drawings constitute a part of this specification and illustrate embodiments of the subject matter disclosed herein.

FIG. 1 shows an e-commerce platform, according to an embodiment.

FIG. 2 shows a home page of an administrator, according to an embodiment.

FIG. 3 shows components of an authentication system, according to an embodiment.

FIG. 4 shows execution steps for authenticating a user, according to an embodiment.

FIGS. 5-6 show examples of notifications displayed by an authentication system, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

For the aforementioned reasons, conducting online transactions using deprecated browsers has become undesirable to both consumers and online merchants. However, because devices executing deprecated browsers have become more ubiquitous, online merchants must identify a method to authenticate users while using deprecated browsers. To solve the above-described problem, an authentication system can use a multi-device and/or multifactor authentication protocol to authenticate users without requiring users to input sensitive information using a deprecated browser. The system can communicate with user devices and/or online merchants to authenticate a user operating a device executing a deprecated browser.

### I. Example E-Commerce Platform

In some embodiments, the methods disclosed herein may be performed on or in association with a commerce platform, such as an e-commerce platform. Therefore, an example of a commerce platform will be described.

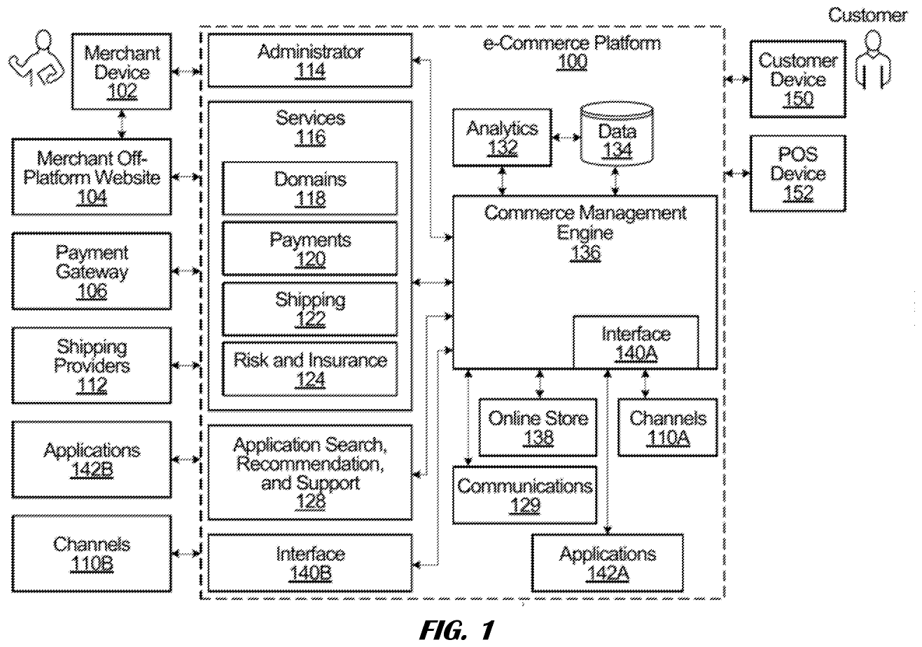

FIG. 1 illustrates an e-commerce platform 100, according to an illustrative system embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), and the like. However, even these ‘other’ merchant commerce facilities may be incorporated into the e-commerce platform 100, such as where POS devices 152 in a physical store of a merchant are linked into the e-commerce platform 100, where a merchant off-platform website 104 is tied into the e-commerce platform 100, such as through ‘buy buttons’ that link content from the merchant off-platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms of online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant device 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The web browser (or other application) of the customer device 150 then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their web site through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g., as data facility 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

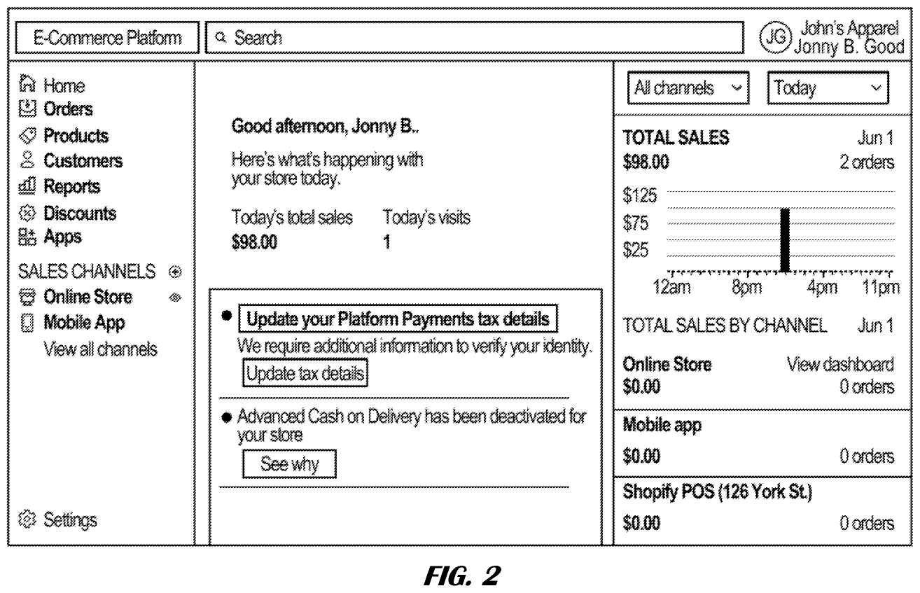

FIG. 2 depicts a non-limiting embodiment for a home page of a merchant administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store 138, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the merchant device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g., via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the e-commerce platform 100 or by a different party. In some embodiments, an application 142B may be provided by the same party providing the e-commerce platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the e-commerce platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the e-commerce platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension or API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third-party, where the third-party application creates a fulfillment record. A legacy fulfillment service may trigger a custom API call from the commerce management engine 136 to a third-party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### II. Example Networked Components of System

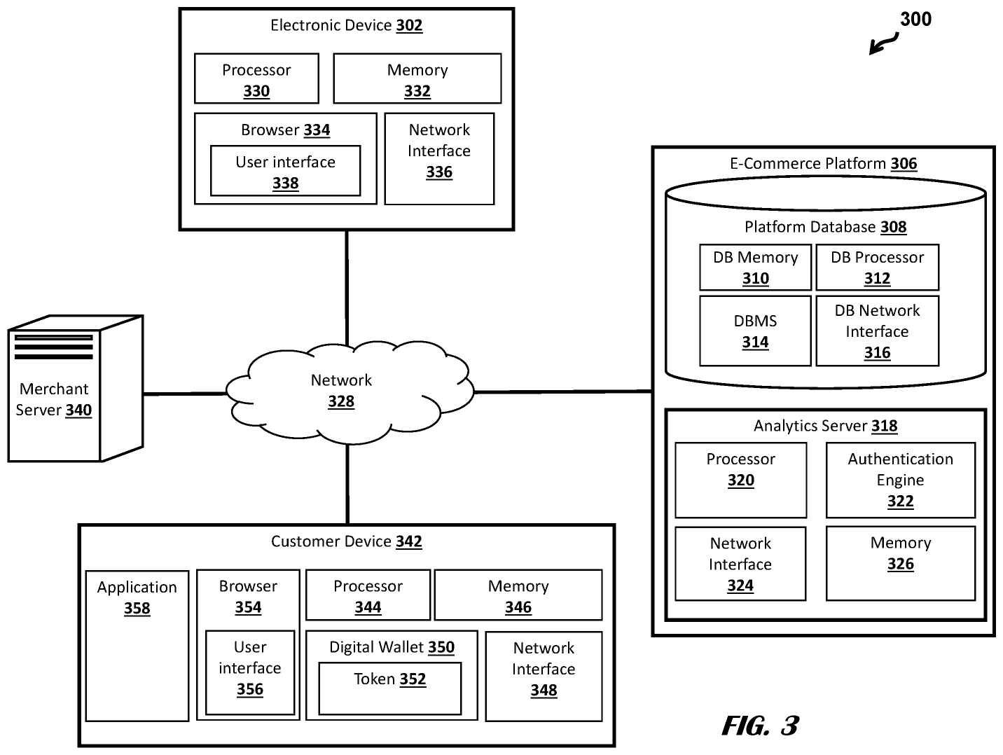

FIG. 3 illustrates components of an authentication system 300, according to an embodiment. The authentication system 300 includes an electronic device 302, a customer device 342, and a merchant server 340 to connect with an e-commerce platform 306 via a network 328. The depicted authentication system 300 is described and shown in FIG. 3 as having one of each component for ease of description and understanding of an example. The embodiments may include any number of the components described herein. The embodiments may comprise additional or alternative components, or may omit certain components, and still fall within the scope of this disclosure.

The network 328 may include any number of networks, which may be public and/or private networks. The network 328 may comprise hardware and software components implementing various network and/or telecommunications protocols facilitating communications between various devices, which may include devices of the authentication system 300 or any number of additional or alternative devices not shown in FIG. 3. The network 328 may be implemented as a cellular network, a Wi-Fi network, or other wired local area network (LAN) or wireless LAN, a WiMAX network, or other wireless or wired wide area network (WAN), and the like. The network 328 may also communicate with external servers of other external services coupled to the network 328 such as servers hosting a social media platform, a banking platform, or the merchant server 340.

The network 328 may include any number of security devices or logical arrangements (e.g., firewalls, proxy servers, DMZs) to monitor or otherwise manage web traffic to the e-commerce platform 306. Security devices may be configured to analyze, accept, or reject incoming web requests from the electronic device 302, the merchant server 340, and/or the customer device 342. In some embodiments, the security device may be a physical device (e.g., a firewall). Additionally or alternatively, the security device may be a software application (e.g., Web Application Firewall (WAF)) that is hosted on, or otherwise integrated into, another computing device of the authentication system 300. The security devices monitoring web traffic are associated with and administered by the e-commerce platform 306.

The electronic device 302 may be any electronic device comprising hardware and software components capable of performing the various tasks and processes described herein. Non-limiting examples of the electronic device 302 may include mobile phones, tablets, laptops, and personal computers, among others. When communicating with components of the e-commerce platform 306, the electronic device 302 may generate web traffic (or web session data) that is processed by or otherwise accessible to the analytics server 318 of the e-commerce platform 306. The web traffic may comprise data packets that include various types of data that can be parsed, analyzed, or otherwise reviewed by various programmatic algorithms of the analytics server 318. For instance, the web traffic data may indicate which website was accessed by a user operating the electronic device 302 (e.g., whether a customer operating the electronic device 302 has accessed a checkout page or requested to be authenticated).

In an example, a customer operating the electronic device 302 visits a website of a merchant (e.g., an online store of the merchant) hosted by the merchant server 340 using the browser 334. The online store may include one or more features hosted (or otherwise produced or functionally controlled) by the analytics server 318. For instance, the analytics server 318 of the e-commerce platform 306 may provide (e.g., host) at least a portion of a webpage for the online store to the electronic device 302 (e.g., checkout page). The browser 334 may transmit and receive data packets in order to display various features of the online store on the user interface 338. The browser 334 (or other application) may connect the electronic device 302 to the analytics server 318 and/or the merchant server 340 using an IP Address obtained by translating a domain name. The analytics server 318 and/or the merchant server 340 may execute code associated with the website and render the appropriate graphics to be presented to the user interface 338.

Even though certain embodiments described herein describe the website as being hosted by the merchant server 340, it is expressly understood that methods and systems described herein also apply to websites associated with the merchant server 340 that are hosted by a third-party webservers. Furthermore, the methods described herein are also applicable in other environments such as non-ecommerce infrastructures and system architectures.

The webpage presented on the user interface 338 may include an electronic cart where the customer can use the browser 334 to add items and complete the transaction by inputting sensitive information such as payment information. However, as will be described below, the browser 334 may be a deprecated browser that does not comply with security standards or other desired protocols of the e-commerce platform 306. For instance, the browser's 334 security protocols may not comply with the latest (e.g., most updated) version required by the e-commerce platform 306.

The electronic device 302 may be a mobile phone, tablet, gaming console, screen-less device, virtual personal assistant device (e.g., screen-less devices), laptop, or computer owned and/or used by a customer. The electronic device 302 may include a processor 330, memory 332, user interface 338, and network interface 336. An example of a user interface 338 is a display screen (which may be a touch screen), a gesture recognition system, a keyboard, a stylus, and/or a mouse. The network interface 336 is provided for communicating over the network 328. The structure of the network interface 336 will depend on how the electronic device 302 interfaces with the network 328. For example, if the electronic device 302 is a mobile phone or tablet, the network interface 336 may include a transmitter/receiver with an antenna to send and receive wireless transmissions to/from the network 328.

If the electronic device 302 is a gaming console connected to the network 328 with a network cable, the network interface 336 may include, for example, a network interface card (NIC), a computer port, and/or a network socket. The processor 330 directly performs or instructs all of the operations performed by the electronic device 302. Non-limiting examples of these operations include processing user inputs received from the user interface 338, preparing information for transmission over the network 328, processing data received over the network 328, and instructing a display screen to display information. The processor 330 may be implemented by one or more processors that execute instructions stored in the memory 332. Alternatively, some or all of the processor 330 may be implemented using dedicated circuitry, such as an ASIC, a GPU, or a programmed FPGA.

The e-commerce platform 306 is a computing system infrastructure that may be owned and/or managed (e.g., hosted) by an e-commerce service and, in some embodiments, may be the same as or similar to that described with reference to FIGS. 1-2, though this need not be the case. The e-commerce platform 306 includes electronic hardware and software components capable of performing various processes, tasks, and functions of the e-commerce platform 306. For instance, the computing infrastructure of the e-commerce platform 306 may comprise one or more platform networks (not shown) interconnecting the components of the e-commerce platform 306. The platform networks may comprise one or more public and/or private networks and include any number of hardware and/or software components capable of hosting and managing the networked communication among devices of the e-commerce platform 306.

As depicted in FIG. 3, the components of the e-commerce platform 306 include the analytics server 318 and a platform database 308. However, the embodiments may include additional or alternative components capable of performing the operations described herein. In some implementations, certain components of the e-commerce platform 306 may be embodied in separate computing devices that are interconnected via one or more public and/or private internal networks (e.g., network 328). In some implementations, certain components of the e-commerce platform 306 may be integrated into a single device. For instance, the analytics server 318 may host the platform database 308.

Furthermore, the e-commerce platform 306 may include the analytics server 318 configured to serve various functions of the e-commerce platform 306. Non-limiting examples of such functions may include webservers hosting webpages (or at least a portion of a webpage, such as the checkout portion) on behalf of merchants (e.g., online stores), security servers executing various types of software for monitoring web traffic (e.g., determining that a customer has reached a checkout page using the electronic device), and database servers hosting various platform databases 308 of the e-commerce platform 306, among others. The analytics server 318 may also perform various methods to authenticate the customer using authorized authenticated sessions and using the customer device 342.

The illustrative e-commerce platform 306 is shown and described as having only one analytics server 318 performing each of the various functions of the e-commerce service. For instance, the analytics server 318 is described as serving the functions of executing the authentication engine 322 and a webserver (hosting webpages for online stores and account administration. It is intended that FIG. 3 is merely illustrative and that embodiments are not limited to the description of authentication system 300 or the particular configuration shown in FIG. 3. The software and hardware of the analytics server 318 may be integrated into a single distinct physical device (e.g., a single analytics server 318) or may be distributed across multiple devices (e.g., multiple analytics servers 318).

For example, some operations may be executed on a first computing device while other operations may be executed on a second computing device, such that the functions of the analytics server 318 are distributed among the various computing devices. In some implementations, the analytics server 318 may be a virtual machine (VM) that is virtualized and hosted on computing hardware configured to host any number of VMs.

The platform database 308 stores and manages data records concerning various aspects of the e-commerce platform 306, including information about, for example, actors (e.g., merchants, consumers, or platform administrators), electronic devices, merchant offerings (e.g., products, inventory, or services), authentication protocols, authentication credentials (e.g., user's passwords or other data needed for authenticating the customers) various metrics and statistics, machine-learning models, merchant pages hosting merchant stores, and other types of information related to the e-commerce platform 306 (e.g., usage and/or services).

The platform database 308 may also include various libraries and data tables including detailed data needed to perform the methods described herein, such as authenticating customers. For instance, the analytics server 318 may generate a data table associated with different browsers and their security features. The analytics server 318 may use this data table to determine whether the browser 334 executing on the electronic device 302 satisfies various security thresholds. In another example, the analytics server 318 may generate a data table associated with different risk appetites discussed herein. As will be described below, the analytics server 318 may use different thresholds and rules based on various factors (e.g. customer attributes or transaction attributes). In order to identify the appropriate threshold or risk appetite, the analytics server 318 may query a data table stored with the platform database 308.

Various predetermined rules, regulations, and thresholds discussed herein may be set by the analytics server 318 or a system administrator of the e-commerce platform 306. Additionally or alternatively, the customer operating the customer device 342 and/or the merchant server 340 may input or modify the predetermined rules. For instance, the analytics server may keep a separate data table including a list of devices associated with a particular customer, which have been previously identified as secure and trusted (e.g., within a list of pre-authorized devices). However, a customer operating the customer device 304 may add or remove different devices from such a list.

The platform database 308 may be hosted on any number of computing devices having a processor (sometimes referred to as a database (DB) processor 320) and non-transitory machine-readable memory configured to operate as a DB memory 310 and capable of performing the various processes and tasks described herein. For example, one or more analytics servers 318 may host some or all aspects of the platform database 308.

A computing device hosting the platform database 308 may include and execute database management system (DBMS) 314 software, though a DBMS 314 is not required in every potential embodiment. The platform database 308 can be a single, integrated database structure or may be distributed into any number of database structures that are configured for some particular types of data needed by the e-commerce platform 306. For example, a first database could store user credentials and be accessed for authentication purposes, and a second database could store raw or compiled machine-readable software code (e.g., HTML, JavaScript) for webpages such that the DB memory 310 is configured to store information for hosting webpages.

The computing device hosting the platform database 308 may further include a DB network interface 324 for communicating via platform networks of the e-commerce platform 306. The structure of the DB network interface 316 will depend on how the hardware of the platform database 308 interfaces with other components of the e-commerce platform 306. For example, the platform database 308 may be connected to the platform network with a network cable, the DB network interface 324 may include, for example, a NIC, a computer port, and/or a network socket. The processor 320 directly performs or instructs all of the operations performed by the platform database 308.

Non-limiting examples of such operations may include processing queries or updates received from the analytics server 318, electronic device 302, customer device 342, and/or merchant server 349; preparing information for transmission via the platform network and/or the external networks 328; and processing data received via the platform network and/or the external networks 328. The processor 320 may be implemented by one or more processors that execute instructions stored in the DB memory 310 or other non-transitory storage medium. Alternatively, some or all of the DB processor 312 may be implemented using dedicated circuitry such as an ASIC, a GPU, or a programmed FPGA.

The DB memory 310 of the platform database 308 may contain data records related to, for example, customer activity, and various information and metrics derived from web traffic involving customer accounts. The data may be accessible to the analytics server 318. The analytics server 318 may issue queries to the platform database 308 and data updates based upon, for example, successful or unsuccessful authentication sessions. As will be described below, the e-commerce platform 306 may generate sessions associated with instances of different customers successfully authenticating their device and/or successfully completing a transaction.

The analytics server 318 may be any computing device that comprises a processor 320 and non-transitory machine-readable storage media (e.g., server memory 326) and that is capable of executing the software for one or more functions such as authentication engine 322. In some cases, the server memory 326 may store or otherwise contain the computer-executable software instructions, such as instruction needed to execute the authentication engine 322. The software and hardware components of the analytics server 318 enable the analytics server 318 to perform various operations that serve particular functions of the e-commerce platform 306.

For example, the analytics server 318 that serves as a webserver may execute various types of webserver software (e.g., Apache® or Microsoft IIS®). As another example, the analytics server 318 that serves as a security server may execute software for authenticating a customer using the customer device 342 when the request is received from the electronic device 302. It is intended that these are merely examples and not intended to be limiting as to the potential arrangements or functions of the analytics server 318. Non-limiting examples of the analytics server 318 may include desktop computers, laptop computers, and tablet devices, among others.

The analytics server 318 may execute the authentication engine 322 that identifies authorized authenticated sessions associated with the customer device 342 and generates tokens used to complete a transaction. The location of the authentication engine 322 is merely an example. The authentication engine 322 may be executed by the analytics server 318 and/or by the customer device 342 under the direction of the analytics server 318. Therefore, the authentication engine 322 can be performed locally on a customer's device or in the back-end of the system 300.

Additionally or alternatively, the authentication engine 322 could be provided by the e-commerce platform 306 as a separate web-based or cloud-based service. In some implementations, the authentication engine 322 is implemented at least in part by a user device such as the customer device 342. Other implementations of the authentication engine 322 are also contemplated such as a stand-alone service to authenticate users of any website. While the authentication engine 322 is shown as a single component of the e-commerce platform 306, the authentication engine 322 could be provided by multiple different components that are in networked communication with the analytics server 318 executing the authentication engine 322.

The customer device 342 may be any electronic device operated by a customer, such as a mobile phone, tablet, laptop, and the like. The customer device 342 may represent an electric device that is known and trusted by the analytics server 318. The customer device 304 includes a processor 344, memory 346, user interface 356, and network interface 348 that are functionally similar to the processor 330, memory 332, user interface 338, and network interface 336. For brevity, description of these features are not repeated. The customer device may also execute a browser 354 functionally similar to the browser 334. However, unlike the browser 334, the browser 354 may execute one or more security protocols that satisfy security thresholds and requirements imposed by the analytics server 318.

The customer device 342 may also include a digital wallet 350. The digital wallet 350 may be a software program executed by the customer device 342 that allows the customer to make electronic transactions in the online merchant store (hosted by the merchant server 340) using digital currency and/or using payment information associated with the customer. As will be described below, the digital wallet 350 may include a token 352 that allows the analytics server 318 to complete a transaction between the customer and the merchant server 340. As will be described below, the token may be generated by the analytics server 318 and may be stored within the platform database 308. In operation, the analytics server 318 may generate the token 352 and store the token within the digital wallet 350. When prompted, the analytics server 318 may invoke an application (e.g., application 358) to complete the transaction using the token 352.

The merchant server 340 may be any server associated with a merchant hosting an online store. The merchant server 340 may be any computing device hosting a website (or any other electronic platform) accessible to customers (e.g., via the electronic device 302 and the customer device 342) via the network 328. The merchant server 340 may include a processing unit and non-transitory machine-readable storage capable of executing various tasks described herein. The processing unit may include a processor with a computer-readable medium, such as a random access memory coupled to the processor. Non-limiting examples of the processor may include a microprocessor, an application specific integrated circuit, and a field programmable object array, among others. Non-limiting examples of the merchant server 340 may include workstation computers, laptop computers, server computers, laptop computers, and the like. While the authentication system 300 includes a single merchant server 340, in some embodiments the merchant server 340 may include a number of computing devices operating in a distributed computing environment.

The merchant server 340 may be configured to interact with one or more software modules of a same or a different types depicted within the authentication system 300. For instance, the merchant server 340 may execute software applications configured to host an electronic platform which may generate and serve various webpages to the electronic device 302. The electronic platform may also embed various graphical user interfaces generated by the analytics server 204. The online store hosted by the merchant server 340 may be configured to require user authentication based upon a set of user authorization credentials (e.g., username, password, biometrics, cryptographic certificate, and the like).

In operation, the analytics server 318 receives a message from the merchant server 340 that a user having a user identifier (UID) has accessed a checkout page on a website hosted or otherwise associated with the merchant server 340. As used herein, a UID may refer to any data that can be used to identify the user. Non-limiting example of a UID may include, a username, email address, phone number, IP address associated with the electronic device 302, MAC address of the electronic device 302, screen name, social media handle, and the like. The message also indicates that the user has utilized the electronic device 302. In response, the analytics server 318 may parse the message and identify whether the browser 334 satisfies one or more security thresholds. In response to the browser 334 not satisfying the security thresholds (e.g., when the analytics server 318 determines that the browser 334 is a deprecated browser), the analytics server 318 queries the platform database 308 to identify an authenticated session associated with the UID. As a result, the analytics server 318 identifies an authenticated session associated with the UID. The analytics server 318 further analyzes the authenticated session and determines that the authenticated session was generated within a predetermined time period of 30 minutes. As a result, the analytics server designates the authenticated session as an authorized authenticated session.

Upon determining that the user operating the electronic device 302 has an authorized authenticated session stored within the platform database 308, the analytics server 318 generates the token 352. The analytics server 318 then queries the platform database and identifies one or more trusted devices associated with the UID. As a result, the analytics server 318 identifies the customer device 342. The analytics server 318 then transmits the token 352 to the customer device 342, whereby the application 358 (that is hosted and functionally controlled by the analytics server 318) authorizes the pending transaction between the electronic device 302 and the merchant server 340. In an alternative embodiments, the analytics server 318 may authorize the transaction without using the application 358. In yet another alternative embodiment, the analytics server 318 may transmit the token 352 to the merchant server 340, whereby the merchant server 340 authorizes transaction.

In response to authorizing the transaction, the analytics server 318 may transmit a notification to the merchant server 340, the customer device 342, and/or the electronic device 302. For instance, the analytics server 318 may generate a second token that informs the merchant server 340 and/or the electronic device 302 that the transaction has been authorized by the analytics server 318. The analytics server 318 may then transmit the second token to the merchant server 340 and/or the electronic device 302. In alternative embodiments, the analytics server 318 may transmit a notification to the merchant server 340 indicating that the transaction has been authorized. In yet another alternative embodiment, the analytics server 318 may transmit an instruction to the electronic device 302 and cause the electronic device 302 to display a confirmation page. Moreover, the analytics server 318 may transmit a push notification to customer device 342 via the application 358 informing the user that the transaction has been authorized.

### III. Example Methods of Authenticating Users

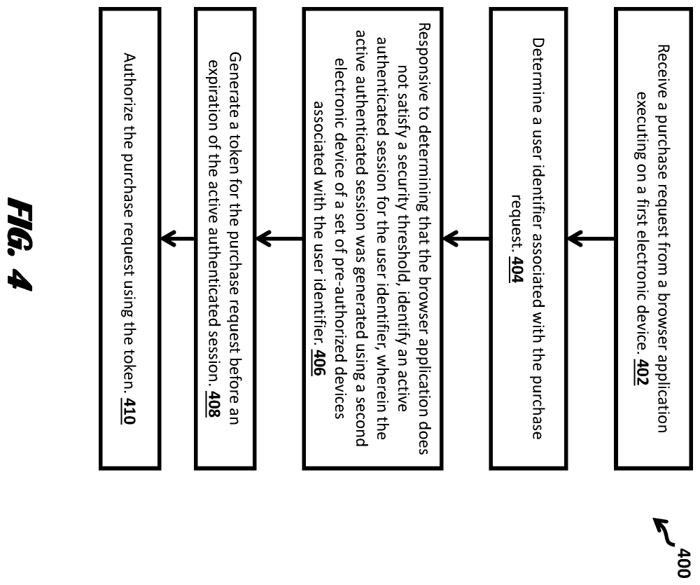

FIG. 4 illustrates a flowchart depicting operational steps for an authentication system, in accordance with an embodiment. The method 400 describes how a server, such as the analytics server described in FIG. 3, can authenticate a user without requiring the user to input any sensitive information using a deprecated browser. Even though the method 400 is described as being executed by the analytics server, the method 400 can be executed by any server and/or locally within a user's trusted device (e.g., customer device discussed in FIG. 3). Additionally or alternatively a server can execute the method 400 in other computer environments (other than the environments depicted in FIGS. 1-3). For instance, the method 400 can be executed by a server providing SaaS in a non-commerce infrastructure for any electronic platform (e.g., authenticating a user on any website regardless of whether the website is related to e-commerce).

Additionally or alternatively, the method 400 can be executed by a webserver acting as both a webserver and the analytics server by hosting the website and executing various authentication methods described herein. Furthermore, other configurations of the method 400 may comprise additional or alternative steps, or may omit one or more steps altogether.

At step 402, the analytics server may receive a purchase request from a browser application executing on a first electronic device. The analytics server may receive an indication that the user has requested to conduct a transaction (also referred to herein as the authentication request or the purchase request) using a primary device that is executing a deprecated browser. The indication may be received from a server associated with an online merchant (e.g., merchant server depicted in FIG. 3 or a webserver that host the merchant's online store). For example, the analytics server may receive, via an electronic message originated from the merchant's server, an indication that a user has added multiple items to his/her electronic cart and has now accessed a checkout page of the merchant's online store. As will be described below, the indication may also include a UID and/or data associated with the items added to the cart by the user. The analytics server may use this information to identify the user, the user's trusted devices, authorized communication channels, and/or tokenize the transaction or the cart.

Additionally or alternatively, the analytics server may monitor a user's electronic device to determine whether the user has requested a check out page. For instance, upon receiving proper authorization from the user, the analytics server may execute various monitoring protocols (e.g., screen scraping or cookie monitoring) to determine a user's activity on the primary device. In a non-limiting example, the analytics server may monitor a browser executing on the primary device. As a result, the analytics server may determine that the user has reached a checked out page of an online store.

At step 404, the analytics server may determine UID associated with the purchase request. The analytics server may identify the UID of the user who requested to conduct a transaction on a first electronic device. Along with the indication that the user has requested a checkout page (step 402), the analytics server may also receive a UID. The UID may be a unique identifier associated with the user, which may be received from the primary device and/or the merchant server. In a non-limiting example, the user may have provided login credentials (e.g., name, login ID, email address, phone number, mailing address, or other personally-identifiable information) using the deprecated browser. In some configurations, when the indication that a user is attempting to checkout is received from the merchant server, the UID may be received from the merchant's server and may include any data that identifies the user (e.g., unique identifier associated with the user or the user's account, such as a cart identifier). In another example, the merchant server may transmit a unique cart ID to the analytics server that can be used to identify the user.

Additionally or alternatively, the analytics server may use a unique identifier of the primary device, such as an IP address, MAC address, or any other identifier associated with the primary device to identify the user. The analytics server may parse the electronic message to determine a unique identified of the primary device. The analytics server may then query a list of known unique identifiers (or unique identifiers that are associated with a user) to identify the user based on the unique identifier. For instance, the analytics server may match the IP address of the primary device (received via the message transmitted by the merchant server) with an IP address associated with the user (e.g., an IP address that is predominantly used by the user to login and access services provided by the analytics server).

Using the UID, the analytics server may then query a database to identify an account of the user, which may include payment information, recent purchases and related sessions, credentials, authorized communication channels and devices, and other user information.

At step 406, in response to determining that the browser application does not satisfy a security threshold, the analytics server may identify an active authenticated session for the UID, wherein the active authenticated session was generated using a second electronic device of a set of pre-authorized devices associated with the UID. Upon receiving the indication (steps 402-404), the analytics server may determine whether the authentication request submitted by the user has been submitted via a deprecated browser. As used herein, a deprecated browser may be a browser that does not satisfy one or more security standards required by the analytics server. An example of a deprecated browser may include a browser that utilizes one or more features that are obsolete or no longer supported by the analytics server or other security software solutions. In another example, security protocols by the browser (or the primary device) may not satisfy the analytics server's security requirements. The deprecated browser may be outdated or may not be equipped to execute security protocols in order to protect networked data and computer systems from breaches of privacy or malware. As a result, deprecated browsers are more susceptible to security exploits. For instance, the primary device may be executing a browser that does not have proper plug-ins to combat and neutralize malware that may read and/or modify the browser memory space.

The analytics server may determine whether the user is utilizing a deprecated browser to access the checkout page. For instance, using metadata associated with the received electronic message, the analytics server may determine attributes associated with the browser used by the user (e.g., the browser executing on the primary device). The analytics server may then query a database (e.g., a look-up table) and identify whether the received attribute(s) indicates that the user is using a deprecated browser.

In an example, the analytics server may parse the electronic message received from the merchant server to determine an identifier of the browser used to request the checkout page on the primary device. The analytics server may then determine, using the identifier, whether the browser can satisfy various security protocols required by the analytics server. For instance, the analytics server may use the identifier to determine the version of the browser used on the primary device. If the browser is not the latest version, the analytics server determines that the browser is a deprecated browser.

Additionally or alternatively, the analytics server may use a unique identifier of the primary device to determine whether the primary device is associated with a deprecated browser. For instance, if a device identifier is associated with a gaming console, then the analytics server determines that the gaming console (the primary device) uses a deprecated browser. In another example, the primary device's unique identifier can indicate that the primary device is a screen-less device (personal virtual assistant devices that use auditory commands to communicate with the user). The analytics server then queries a look-up table and identifies the screen-less device as a device associated with a predetermined list of deprecated browsers. In various configurations, the device identifier can be hardware-based (e.g., a MAC address or similar) and/or software-based (e.g., an IP address or similar).

When the analytics server determines that the primary device is executing a deprecated browser, the analytics server may authenticate the user using a trusted device (also referred herein as the secondary device). As will be described below, the analytics server may authenticate the user using methods and systems that reduce the role of the primary device due to security concerns. As a result, the analytics server may no longer require the user to input any sensitive data using the deprecated browser.

Upon determining that the user is operating a deprecated browser, the analytics server may identify an active authenticated session for the user identifier (UID) on a second electronic device. The analytics server may identify an active (e.g., authorized) authenticated session associated with the received UID on a trusted device (secondary device). The system queries various databases (e.g., look-up table) to determine whether an active authenticated session for the user exists.

A session, as used herein, may refer to a temporary and interactive information interchange between the analytics server and an electronic device operated by the user. For instance, the analytics server may generate a session when the analytics server completes a transaction associated with the user. In another example, the analytics server may generate a session for the user when the analytics server successfully authenticates the user. In an example, the analytics server generates a session when the user attempts to “check out” using the user's mobile phone (e.g., using a mobile application hosted or otherwise in communication with the system). Using various authentication protocols, the analytics server determines whether credentials inputted by the user (purportedly authenticating the user) match an appropriate set of credentials that identify and authenticate the user. When the user is successfully authenticated, the analytics server modifies the session to an authenticated session.

An authorized authenticated session may refer to an authenticated session that satisfies one or more thresholds, such as timing thresholds and/or identifier thresholds. For instance, depending on risk appetite, the analytics server may apply a time threshold to the identified authenticated sessions (e.g., one hour or 30 minutes). The analytics server may identify all authenticated sessions associated with the user that are also associated with a trusted device (secondary device). The analytics server may then analyze the identified authenticated sessions and may determine if an identified authenticated session satisfies the time threshold. For example, if an authenticated session was generated within the last hour using a trusted device, the analytics server designates the authenticated session as an authorized authenticated session. However, if the authenticated session is associated with a device that is unknown to the analytics server or if the authenticated session was generated outside the time threshold, the analytics server does not consider the authenticated session as an authorized authenticated session.

The analytics server may use any data associated with an authenticated session to determine whether the authenticated session is an authorized authenticated session. In an example, the analytics server may use a device identifier associated with the authenticated session to determine whether the authenticated session is authorized. Accordingly, the analytics server may determine that an authenticated session is not authorized because the credentials were received from an unknown device or an unknown IP address. In an example, the analytics server may identify an authenticated session associated with the user. The analytics server may further analyze the session and determine that the session is not associated with a trusted device (e.g., a device that has been previously designated as a trusted device and included in a pre-authorized list of devices). For instance, the user may have conducted an online transaction using a work computer or a mobile device associated with his/her friend. The analytics server may determine that the authenticated session is not authorized to be used to authenticate the user on the primary device because the session was not initiated on a trusted device (even though the session was successfully authenticated).

The analytics server may also determine whether an authenticated session is authorized based on the received UID. For instance, the analytics server may determine that an existing authenticated session is not authorized because an IP address of the device executing the deprecated browser does not match (at least partially an IP address of the authenticated session. This may indicate that the two devices are not on the same network or sub-network. In this example, the authorized authenticated session must be associated with a secondary device that is connected to the analytics server (or the merchant server) using the same Internet connection (e.g., Wi-Fi network) as the primary device.

In a non-limiting example, the analytics server may query and identify an existing authenticated session associated with a user. In order to determine whether the existing authenticated session is authorized to be used for further authentication of the user, the analytics server may further analyze the existing authenticated session. Specifically, the analytics server may determine a unique identifier of a network connection used in association with the existing authenticated session. For instance, the analytics server may analyze the existing authenticated session to determine an IP address associated with the network used by the user to conduct the transaction (e.g., an IP address associated with the session). The analytics server may then compare the IP address associated with the existing authenticated session with an IP address (or any other identifier of the network) associated with the primary device. If the analytics server determines that the authenticated session is associated with the same network as being used by the primary device (e.g., at least a portion of the IP addresses match), the analytics server determines that the authenticated session is an authorized authenticated session.

The criteria indicating whether an authenticated session is authorized may be predetermined or provided by a system administrator and/or the user. In an example, a user may indicate that the analytics server may not use existing authenticated sessions that are older than fifteen minutes. As a result, any authenticated session (even when associated with a trusted device or associated with the same network) cannot be authorized if it was created outside the predetermined fifteen-minute time threshold. Moreover, the authorization criteria may be revisable by the user, system administrator, and/or by the system using a set of predetermined rules. Therefore, the time threshold used by the analytics server may depend on the transaction and/or the user. The analytics server may use different authorization criteria that depend upon different risk appetites and/or based on transaction attributes. For instance, the analytics server may apply a different authorization criteria based on the purchase amount, user geographic area, and/or purchase history.

In alternative embodiments, the active (authorized) authenticated session may not be limited to sessions associated with the secondary device. For instance, when risk appetite allows, the system may determine that an authenticated session is authorized even when the session was generated using a device that is not known to the analytics server.

At step 408, the analytics server may generate a token for the purchase requested on the first electronic device. When the analytics server identifies an authorized authenticated session associated with the secondary device, the system may generate a token corresponding to the user and/or the ongoing transaction. The token can include one or more concatenated data elements that correspond to the transaction data received from the merchant server, UID, cart/transaction information, and/or the user profile. For instance, the token may include financial information (e.g., credit card number), authentication information (e.g., user name, PIN, password, device), shopping cart information (e.g., shopping cart identifier, user, expiration date, associated payment session identifier), and/or product information (e.g., product identification or quantity).

The token can include an alphanumeric value and/or special characters. The data element may be individually tokenized—for example, a unique value (hash) may be generated for each data element using a hashing algorithm, and the unique values may then be concatenated. The token may also be encrypted for transmission and/or when stored by the analytics server.

In an example, the analytics server may communicate with the merchant server (or the primary device) and may receive data associated with the cart (e.g., timestamp or items added to the cart by the user) and the UID. The analytics server may then generate the token using the data received such that the token is unique to the user and the cart (e.g., the token is unique to the pending transaction). The token may be valid within a predetermined window of time. For instance, when generating the token, the analytics server may ensure that the token can only be used to authorize the pending transaction (purchase request) when used within a predetermined window of time (e.g., 5, 10, or 15 minutes).

In an alternative embodiment, the analytics server may generate the token and securely store the token within a data repository (e.g., internal database or locally on the secondary device or the user's digital wallet). The analytics server may generate the token before the authorized authenticated session expires. For instance, when the time threshold is set to 30 minutes, the analytics server may generate the token

In some configurations, the analytics server may require an additional layer of security before generating the token or before authorizing the transaction. The analytics server may execute a multi-factor authentication protocol. For instance, the analytics server may identify an authorized electronic communication channel associated with the user and transmit a notification prompting the user to confirm the transaction. The analytics server may query a database and determine whether the user has installed an application associated with the analytics server on one or more electronic devices. If the user has installed the application, the analytics server may transmit a push notification to the user through the application. If the user has not installed the application, the analytics server may transmit the notification using another communication channel (e.g., text message or email).

The notification may include data associated with the transaction. For instance, the notification may include the price and items included in the cart. The notification may also include an interactive button where the user can confirm or deny the transaction. Additionally or alternatively, the notification may also include a passcode and an instruction for the user to enter the passcode using an input element of the primary device executing the deprecated browser. Additionally or alternatively, the notification may include an input element in conjunction with a prompt requesting the user to enter a passcode displayed on a display screen of the primary device.

Additionally or alternatively, the notification may prompt the user to transmit an image of a display screen of the primary device (deprecated browser) where the deprecated browser may display an encrypted visual element (e.g., QR code or a watermark element). The analytics server may use the received image as the secondary authentication credential. In the embodiments where the primary device is a screen-less device, the system may use a voice authentication protocol as the secondary authentication measure. The voice authentication protocol may be executed by the analytics server and/or third party server, such as a server associated with the screen-less device.

The analytics server may apply the additional security layer based on various rules. For instances, the analytics server may execute the multi-factor authentication protocol when the transaction satisfies a price threshold (e.g., more than $500) or when the authenticated session does not satisfy all the above-described criteria (e.g., the authenticated session is older than the time threshold or is associated with a device that is not trusted).

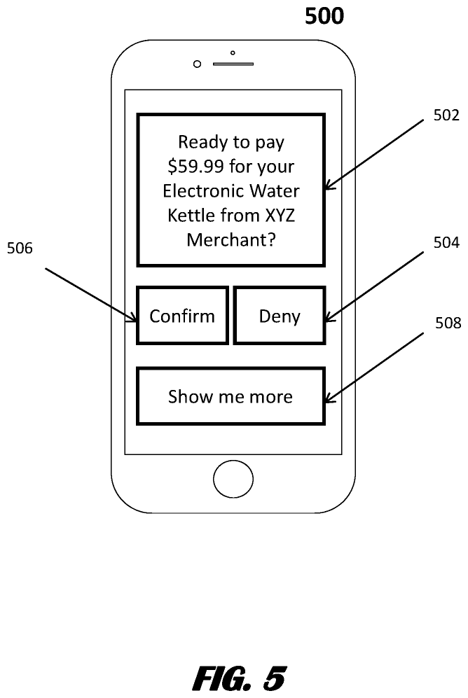

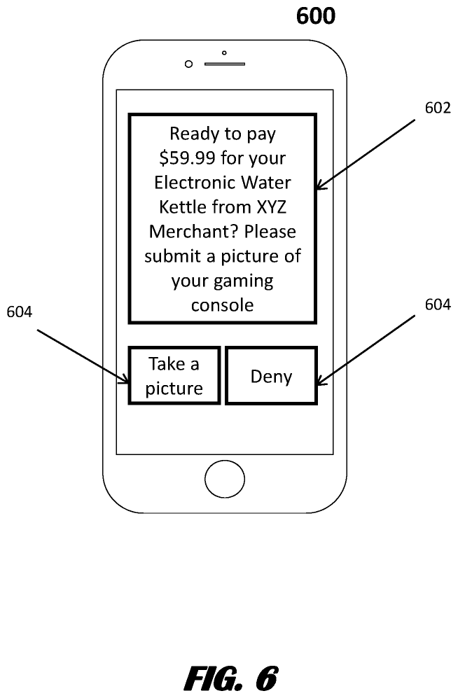

Referring now to FIGS. 5-6, non-limiting examples of using multi-factor authentication protocols are illustrated. The analytics server may identify an authorized communication channel and may display a notification to provide additional security, as discussed herein. In the depicted embodiment, the analytics server determines that the user has downloaded an application hosted or otherwise associated with the analytics server on a trusted device (mobile device 500). As a result, the analytics server transmits a push notification to the mobile device 500. The push notification may include the text 502 that describes the purchase request (pending transaction). Specifically, the text 502 describes the item, price, and the online merchant's name. The push notification may also include the interactive buttons 504-508. As depicted, the user may utilize the interactive buttons 504 and 506 to confirm or deny the transaction. The user may also utilize the interactive button 508 to view detailed data associated with the ongoing transaction. When the analytics server receives an indication that the user has interacted with the interactive button 508, the analytics server directs the user to that website of the online merchant and/or displays an indication of the cart.

In another example, the push notification (transmitted to the mobile device 600) may include the text 602. Similar to the text 502, the text 602 describes the purchase request and provides cart information to the user. The text 602 may also prompt the user to take a picture of the primary device. As described herein, the analytics server may display an encrypted visual elements on the display screen of the primary device. The analytics server may authenticate the user using an image received from a trusted device (the mobile device 600) that includes the encrypted visual element displayed on the primary device. In some configurations, the encrypted visual element may be a watermark element that is unrecognizable to human eye. When prompted, the user may interact with interactive button 604 to activate a camera of the mobile device 600 and transmit an image of a display screen of the primary device to the analytics server. The user may also interact with the interactive button 604 to deny the transaction.

Referring back to FIG. 4, at step 408, the analytics server may authorize the transaction using the token. The analytics server may complete the transaction using the generated token. In one embodiment, the analytics server may transmit the token to an application executing on the trusted device (secondary device). Upon receiving the token, the application may complete the transaction. In another embodiment, the analytics server may transmit the token to a server associated with the online merchant (e.g., merchant server). Using the token, the merchant server may complete the transaction. In yet another embodiment, the analytics server may transmit the token to the primary device whereby the primary device uses the token to authenticate the user. For instance, the primary device may transmit the token to a server associated with the merchant server thereby allowing the merchant server to authenticate the user. Because the primary device may not execute a browser that can satisfy predetermined security thresholds, in embodiments where the token is transmitted to the primary device, the analytics server may encrypt the token. As a result, a bad actor accessing the primary device and the token may be unable to inappropriately utilize a token to authenticate a fraudulent transaction.

Upon the analytics server authorizing the transaction, the analytics server may notify the user. The analytics server may transmit a confirmation notification using the electronic communication channels discussed herein (e.g., text message, email, or push notification when the user has installed the application). Additionally or alternatively, the analytics server may instruct the primary device to display a confirmation page. In some configurations, the analytics server may generate a second token that includes confirmation data associated with the authorized transaction. The second token, unlike the first token discussed above, may not include any personally identifiable or otherwise sensitive information. Therefore, the analytics server may send the second token directly to the primary device with limited security risk. Upon receiving the second token, the primary device may display the confirmation page. In another example, the analytics server may transmit the second token to the merchant server that in turn instructs the primary device to display the confirmation page.

The methods and systems described herein can be used to authenticate a user operating a deprecated browser, such that the user is not required to input any sensitive information (e.g., password or payment information) using the deprecated browser. For instance, the methods and systems described herein can be used to authorize a pending transaction without requiring the user to input any sensitive data (either via the deprecated browser or other devices). In a non-limiting example, a user accesses an online store (e.g., website of a merchant) via a gaming console. The user then adds a product to an electronic cart and requests a checkout.

A webserver of the online store may then transmit a message to the analytics server indicating that the user is requesting to authorize a pending transaction via a gaming console. The analytics server analyzes the message to identify a UID and to further identify a browser application executed by gaming console. If the browser application does not satisfy one or more security protocols, the analytics server then queries one or more databases to determine whether the UID is associated with an authenticated session that is also associated with a trusted device (e.g., whether the user has successfully authenticated himself/herself using a pre-authorized device, such as the user's mobile device).

Upon identifying an authenticated session, the analytics server further analyzes the authenticated session to determine whether the authenticated session can be appropriately used to authorize the user's pending transaction. Specifically, the analytics server applies a series of rules and threshold to determine whether the identified authenticated session is an authorized (or active) authenticated session. For instance, the analytics server identifies a timestamp of the authenticated session. If the authenticated session was created using a trusted device within a time threshold that complies with the rules and thresholds, the analytics server determines that the authenticated session is an authorized authenticated session.

Upon identifying the existence of an authorized authenticated session, the analytics server generates a token for the pending transaction that includes the user's sensitive information, such as the user's payment information. The analytics server then transmits the token to an application executing on the trusted device (e.g., user's mobile phone) where the application authorizes the pending transaction using the token.

In an embodiment, a method may comprise receiving, by a computer, a purchase request from a browser application executing on a first electronic device; determining, by the computer, a user identifier associated with the purchase request; responsive to determining that the browser application does not satisfy a security threshold, identifying, by the computer, an active authenticated session for the user identifier, wherein the active authenticated session was generated using a second electronic device of a set of pre-authorized devices associated with the user identifier; generating, by the computer, a token for the purchase request before an expiration of the active authenticated session; and authorizing, by the computer, the purchase request using the token.

The computer may generate the token using at least one of the user identifier, data associated with the purchase request, authentication data associated with the user identifier, or payment data associated with the user identifier.

The active authenticated session may correspond to an authenticated session having a timestamp that satisfies a time threshold.

The active authenticated session may correspond to an authenticated session having an identifier that at least partially matches an identifier of the first electronic device.

The method may further comprise transmitting, by the computer, a notification to the second electronic device associated with the user identifier, the notification prompting second electronic device to confirm an attribute of the purchase request.

The computer may authorize the purchase request by transmitting the token to a server of an online merchant associated with the purchase request.

The computer may authorize the purchase request via an application executing on the second electronic device.

The first electronic device may be a gaming console or a screen-less virtual assistant device.

The method may further comprise generating, by the computer, a second token indicating that the purchase request has been authorized; and transmitting, by the computer, the second token to the first electronic device.

In another embodiment, a machine-readable storage medium may comprise computer-executable instructions stored thereon that, when executed by one or more processors, cause the one or more processors to perform operations comprising: receive a purchase request from a browser application executing on a first electronic device; determine a user identifier associated with the purchase request; responsive to determining that the browser application does not satisfy a security threshold, identify an active authenticated session for the user identifier, wherein the active authenticated session was generated using a second electronic device of a set of pre-authorized devices associated with the user identifier; generate a token for the purchase request before an expiration of the active authenticated session; and authorize the purchase request using the token.

The one or more processors may generate the token using at least one of the user identifier, data associated with the purchase request, authentication data associated with the user identifier, or payment data associated with the user identifier.

The active authenticated session may correspond to an authenticated session having a timestamp that satisfies a time threshold.

The active authenticated session may correspond to an authenticated session having an identifier that at least partially matches an identifier of the first electronic device.

The instructions may further cause the one or more processors to transmit a notification to the second electronic device associated with the user identifier, the notification prompting the second electronic device to confirm an attribute of the purchase request.

The one or more processors may authorize the purchase request by transmitting the token to a server of an online merchant associated with the purchase request.

The one or more processors may authorize the purchase request via an application executing on the second electronic device.

The first electronic device may be a gaming console or a screen-less virtual assistant device.

The instructions may further cause the one or more processors to: generate a second token indicating that the purchase request has been authorized; and transmit the second token to the first electronic device.

In another embodiment, a system may comprise a server having a processor in communication with a first electronic device configured to execute an application, the server configured to: receive a purchase request from a browser application executing on a second electronic device; determine a user identifier associated with the purchase request; responsive to determining that the browser application does not satisfy a security threshold, identify an active authenticated session for the user identifier, wherein the active authenticated session was generated using the second electronic device of a set of pre-authorized devices associated with the user identifier; generate a token for the purchase request before an expiration of the active authenticated session; and authorize, via the application, the purchase request using the token.

The active authenticated session may correspond to an authenticated session having a timestamp that satisfies a time threshold.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by a computer, a purchase request from a browser application executing on a first electronic device;
determining, by the computer, a user identifier associated with the purchase request;
responsive to determining that the browser application does not satisfy a security threshold, identifying, by the computer, an active authenticated session for the user identifier, wherein the active authenticated session was generated using a second electronic device of a set of pre-authorized devices associated with the user identifier;
generating, by the computer, a token for the purchase request before an expiration of the active authenticated session; and
authorizing, by the computer, the purchase request using the token.

2. The method of claim 1, wherein the computer generates the token using at least one of the user identifier, data associated with the purchase request, authentication data associated with the user identifier, or payment data associated with the user identifier.

3. The method of claim 1, wherein the active authenticated session corresponds to an authenticated session having a timestamp that satisfies a time threshold.

4. The method of claim 1, wherein the active authenticated session corresponds to an authenticated session having an identifier that at least partially matches an identifier of the first electronic device.

5. The method of claim 1, further comprising:
transmitting, by the computer, a notification to the second electronic device associated with the user identifier, the notification prompting second electronic device to confirm an attribute of the purchase request.

6. The method of claim 1, wherein the computer authorizes the purchase request by transmitting the token to a server of an online merchant associated with the purchase request.

7. The method of claim 1, wherein the computer authorizes the purchase request via an application executing on the second electronic device.

8. The method of claim 1, wherein the first electronic device a gaming console or a screen-less virtual assistant device.

9. The method of claim 1, further comprising:
generating, by the computer, a second token indicating that the purchase request has been authorized; and
transmitting, by the computer, the second token to the first electronic device.

10. A machine-readable storage medium having computer-executable instructions stored thereon that, when executed by one or more processors, cause the one or more processors to perform operations comprising:
receive a purchase request from a browser application executing on a first electronic device;
determine a user identifier associated with the purchase request;
responsive to determining that the browser application does not satisfy a security threshold, identify an active authenticated session for the user identifier, wherein the active authenticated session was generated using a second electronic device of a set of pre-authorized devices associated with the user identifier;
generate a token for the purchase request before an expiration of the active authenticated session; and
authorize the purchase request using the token.

11. The machine-readable storage medium of claim 10, wherein the one or more processors generate the token using at least one of the user identifier, data associated with the purchase request, authentication data associated with the user identifier, or payment data associated with the user identifier.

12. The machine-readable storage medium of claim 10, wherein the active authenticated session corresponds to an authenticated session having a timestamp that satisfies a time threshold.

13. The machine-readable storage medium of claim 10, wherein the active authenticated session corresponds to an authenticated session having an identifier that at least partially matches an identifier of the first electronic device.

14. The machine-readable storage medium of claim 10, wherein the instructions further cause the one or more processors to:
transmit a notification to the second electronic device associated with the user identifier, the notification prompting the second electronic device to confirm an attribute of the purchase request.

15. The machine-readable storage medium of claim 10, wherein the one or more processors authorize the purchase request by transmitting the token to a server of an online merchant associated with the purchase request.

16. The machine-readable storage medium of claim 10, wherein the one or more processors authorize the purchase request via an application executing on the second electronic device.

17. The machine-readable storage medium of claim 10, wherein the first electronic device a gaming console or a screen-less virtual assistant device.

18. The machine-readable storage medium of claim 10, wherein the instructions further cause the one or more processors to:
generate a second token indicating that the purchase request has been authorized; and
transmit the second token to the first electronic device.

19. A system comprising:
a server having a processor in communication with a first electronic device configured to execute an application, the server configured to:
receive a purchase request from a browser application executing on a second electronic device;
determine a user identifier associated with the purchase request;
responsive to determining that the browser application does not satisfy a security threshold, identify an active authenticated session for the user identifier, wherein the active authenticated session was generated using the second electronic device of a set of pre-authorized devices associated with the user identifier;
generate a token for the purchase request before an expiration of the active authenticated session; and
authorize, via the application, the purchase request using the token.

20. The system of claim 19, wherein the active authenticated session corresponds to an authenticated session having a timestamp that satisfies a time threshold.
